(19) United States
(12) Patent Application Publication
(10) Pub. No.: US 2010/0030676 A1
(43) Pub. Date: Feb. 4, 2010

(54) Auto Increment In Financial Calculation

(76) Inventor: Cyrille de Brebisson, Boise, ID (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/242,581

(22) Filed: Sep. 30, 2008

Related U.S. Application Data
(60) Provisional application No. 61/085,357, filed on Jul. 31, 2008.

(51) Int. Cl. G06Q 40/00; G06F 15/02

(52) U.S. Cl. 705/35

(57) ABSTRACT

A system comprises a processor, a keyboard and display. The keyboard is coupled to the processor and comprises a financial calculation key and a selection key. The display also is coupled to the processor. When the financial calculation key is pressed, the processor performs a financial calculation. The financial calculation computes financial data over multiple time periods. Further, the processor sequences through and displays the computed financial data and automatically increments from a current time period to a subsequent time period upon a user repeatedly pressing the selection key.

### CROSS-REFERENCE TO RELATED APPLICATION

This application claims the benefit of Provisional Patent Application No. 61/085,357, filed Jul. 31, 2008, and titled, “AUTO INCREMENT IN FINANCIAL CALCULATION”, the entirety of which is hereby incorporated by reference herein.

### BACKGROUND

Some calculations result in multiple output data values. Financial calculations such as amortization calculations result in computed output data values that span multiple time periods. For example, an amortization table specifies the principle, interest and balance data over the course of the life of the loan. Reviewing such multiple output values on a hand-held calculator with a very limited display is very awkward.

### BRIEF DESCRIPTION OF THE DRAWINGS

For a detailed description of exemplary embodiments of the invention, reference will now be made to the accompanying drawings in which:

FIG. 1 shows a calculator in accordance with embodiments of the invention;

FIG. 2 shows a system block diagram of the calculator of FIG. 1;

FIG. 3 shows an illustrative amortization schedule that can be displayed on the calculator of FIG. 1;

FIG. 4 illustrates the information shown on the display of the calculator when sequencing through the computed amortization schedule of FIG. 3 in accordance with various embodiments;

FIG. 5 shows an illustrative depreciation schedule that can be displayed on the calculator of FIG. 1;

FIG. 6 illustrates the information shown on the display of the calculator when sequencing through the computed depreciation schedule of FIG. 5 in accordance with various embodiments; and

FIG. 7 shows a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

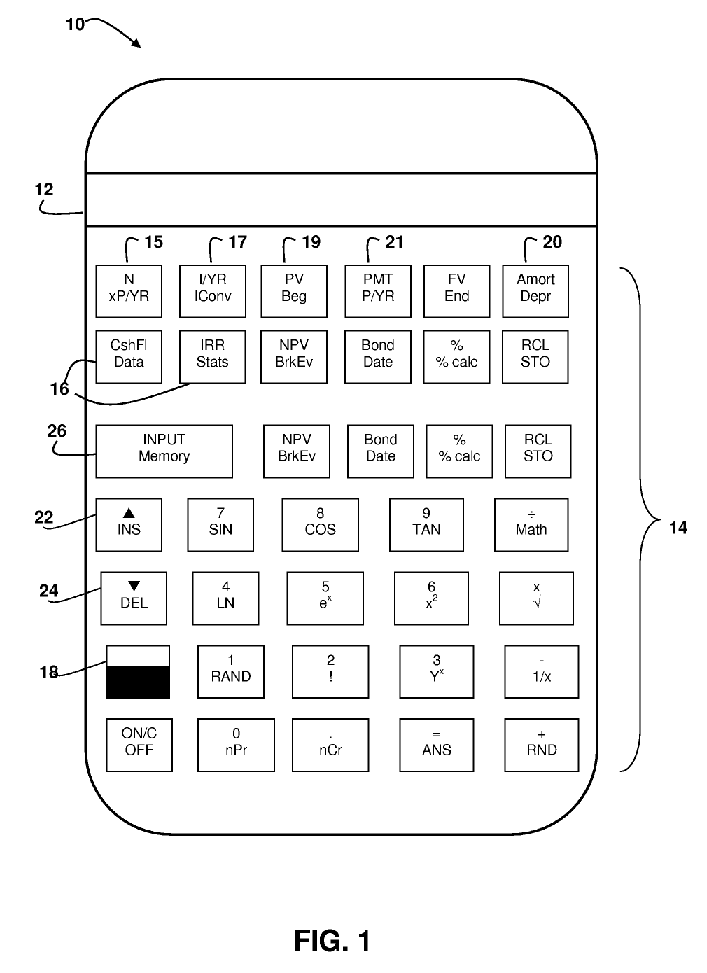

FIG. 1 shows an embodiment of an electronic computing system 10. In the embodiment shown, the electronic computing system 10 is a hand-held, battery-operated calculator and is referred to as a calculator in this disclosure. The calculator 10 comprises a display 12 and keyboard 14. In some embodiments, the display 10 is a 1 or 1.5 line display. A 1.5 line display means that one line is used for numbers as well as text and a second line is used for numbers only. The keyboard 14 includes multiple buttons 16, many of which have more than one function assigned thereto. Of the keyboard's buttons 16, the following buttons are discussed herein: number of periods (N) button 15, yearly interest (I/YR) button 17, present value (PV) button 19, amortization/depreciation button 20, payment (PMT) key 21, shift button 18, up arrow button 22, down arrow button 24, and input button 26. The up and down arrow buttons 22, 24 comprise direction keys that permit a user to navigate up and down through a set of choices presented on the display 12. The terms “button” and “key” are used synonymously in this disclosure.

The shift button 18 is pressed to select the lower-most function of any of the buttons 16. If the depreciation (Depr) function is desired on the amortization/depreciation button 20, the shift button 18 is pressed first followed by amortization/depreciation button 20. If the shift button 18 is not pressed, then pressing the amortization/depreciation button 20 (without pressing the shift button 18) selects the amortization (AMORT) function.

The calculator 10 is able to perform at least two financial calculations including amortization and depreciation. Amortization calculations require the input of the number of periods (N), yearly interest (I/YR) and present value (PV) and the N, I/YR, and PV buttons 15, 17, and 19, respectively, are used for that purpose.

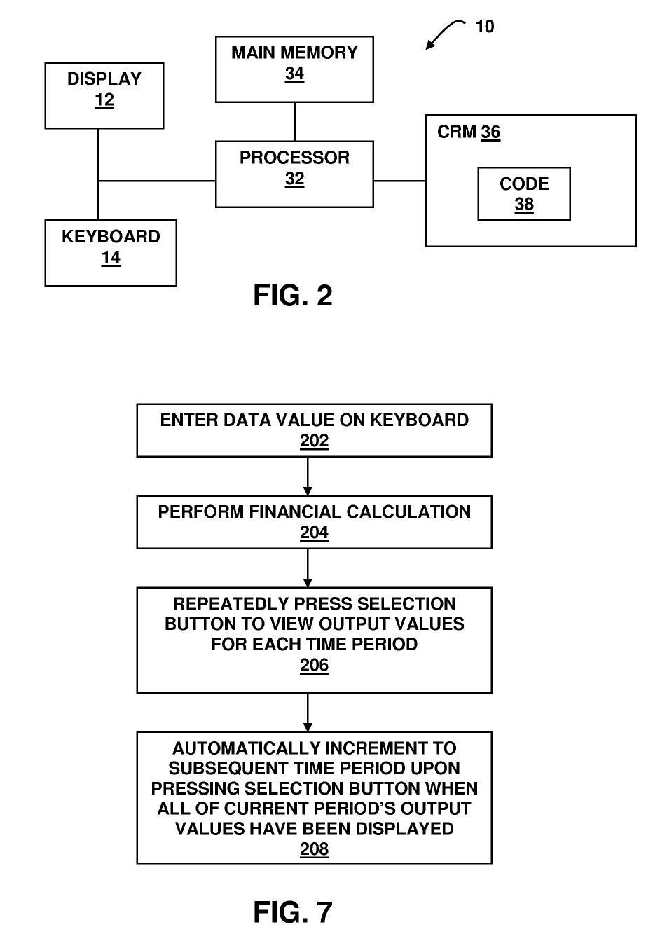

FIG. 2 illustrates an electrical block diagram of the calculator 10. As shown, the calculator 10 comprises a processor 32 coupled to the display 12 and keyboard 14, as well as to main memory 34 and a computer-readable memory (CRM) 36. Code 38 is stored on the CRM 36 and is executed by processor 32. Some or all of the functionality described herein is implemented in code 38. The CRM 36 comprises volatile memory (e.g., random access memory), non-volatile storage (read-only memory (ROM)), hard disk drive, Flash memory, etc.), or combinations thereof.

In accordance with various embodiments, calculator 10 can perform one or more financial calculations, the results of which involve data over multiple time periods. Examples of such financial calculations include amortization and depreciation calculations. Amortization and depreciation calculations require input data. The calculator 10 can be used to enter the required input data. The calculator can also be used display the resulting computed data. Due to the relatively small size of display 12 and the large amount of computed data to be viewed, the calculator 10 enables a user to scroll the all of the output data for a given time period (e.g., a given year) and then automatically increment to the subsequent time period. This process is illustrated below.

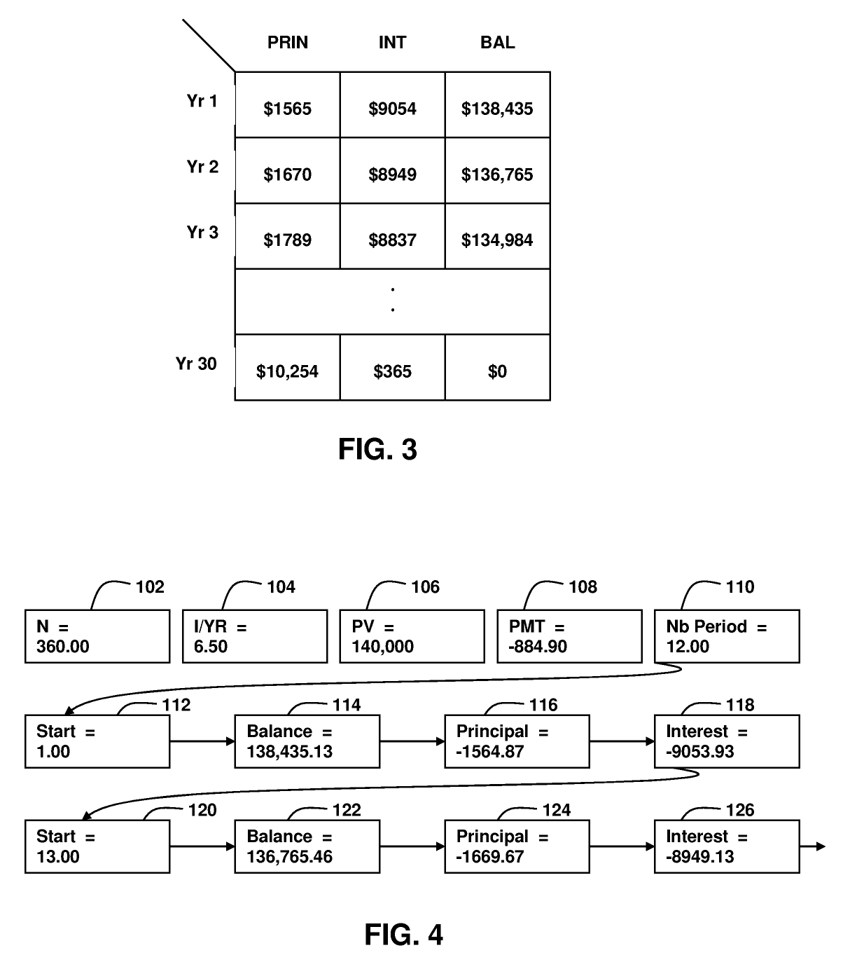

FIG. 3 provides a portion of the output data from an illustrative amortization calculation. The input data to the illustrative amortization calculation is an interest rate (I/YR) of 6.5%, a present value (PV) of $140,000 and payment over 360 months (30 years, N). These values are input via keyboard 14 in any order. For example, the user can enter “6.5” and then press the I/YR key 17. The user may next enter 140000 and then press the PV key 19. Finally, the user can enter 360 and then press the N key 15. Once this data is entered, the user can press the PMT key 21 and the calculator will display the monthly payment for the loan. In this example, the monthly payment will be $884.90.

If the user presses the AMORT key 20, the calculator 10 will compute the amortization schedule for the loan. This data includes, for each time period (e.g., each year), the total amount of interest paid for that time period, the total amount of principal paid for the time period and the resulting balance for the time period. As shown in FIG. 3, the total amounts of principal and interest paid for the first year are $1565 and $9054, respectively. The remaining balance is $138,435. The principal, interest, and remaining balance for the second year are $1670, $8949 and $136,765, respectively. Values for principal, interest and remaining balance are calculated for the remaining years ending at year 30 in which the remaining balance is 0 and the principal and interest paid is $10,254 and $365, respectively. All of these output data values can be shown on the display 12 of calculator 10 by the user repeatedly pressing a selection key. In accordance with various embodiments, the selection key is the down arrow key 24.

FIG. 4 illustrates the process of entering the input data to the amortization calculation as well as what is shown on display 12 each time the user presses the down arrow key after pressing the AMORT key 20 to cause the amortization calculation to be performed. After the user enters the number of payment periods (360 in this example) and presses the N key 15, the display 12 shows that N=360.00 as depicted at 102. Reference numerals 104 and 106 illustrate what is shown on the display 12 after the user enters the interest rate (6.5%) and present value ($140,000). Reference numeral 108 illustrates the display ($884.90) upon the user pressing the PMT key 21. At 110, the user has pressed the AMORT key 20. As a result, the calculator 10 shows the number of payments per time period (12 in this example). This value can be changed by the user entering a new value and pressing the INPUT key 26.

At this point, the use repeatedly presses the down arrow key 24 to scroll the amortization table data of FIG. 3. The connecting arrows illustrate display sequences resulting from repeated activation of the down arrow key 24. Reference numeral 112 identifies the first time period. The start value of 1.00 refers to month 1 which is the first month in year 1. Pressing the down arrow key 24 again causes the calculator 10 to display the balance after year 1 ($138,435.13). Pressing the down arrow key 24 again causes the principal amount paid in year 1 of $1564.87 to be displayed and pressing the down arrow key yet again causes the interest paid in year 1 of $9053.93 to be displayed.

Once the last data value in the year 1 (the interest) has been paid, pressing the down arrow key 24 again causes the calculator 10 to automatically increment to the next time period which begins with month 13 (year 2). Repeatedly pressing the arrow key 24 causes the display to change from the balance at year 2 to the principal paid in year 2 to the interest paid in year 2. Pressing the arrow key again causes an automatic increment to the next time period, and so on.

In some embodiments, pressing the up arrow key 22 causes the output data values to be displayed in the reverse order from that described above with automatic decrement to the preceding time period. In yet other embodiments, there is no automatic decrement to the preceding time period and pressing the up arrow key only causes the calculator 10 to scroll backward through the current time period's output values (e.g., interest to principal to balance).

By automatically incrementing from a current time period to the subsequent time period (by pressing the down arrow key 24), the user of the calculator 10 need not manually input a new time period to view data. Further, only one selection key (e.g., down arrow key 24) need be pressed to scroll through some or all of the amortization output values over the various time periods.

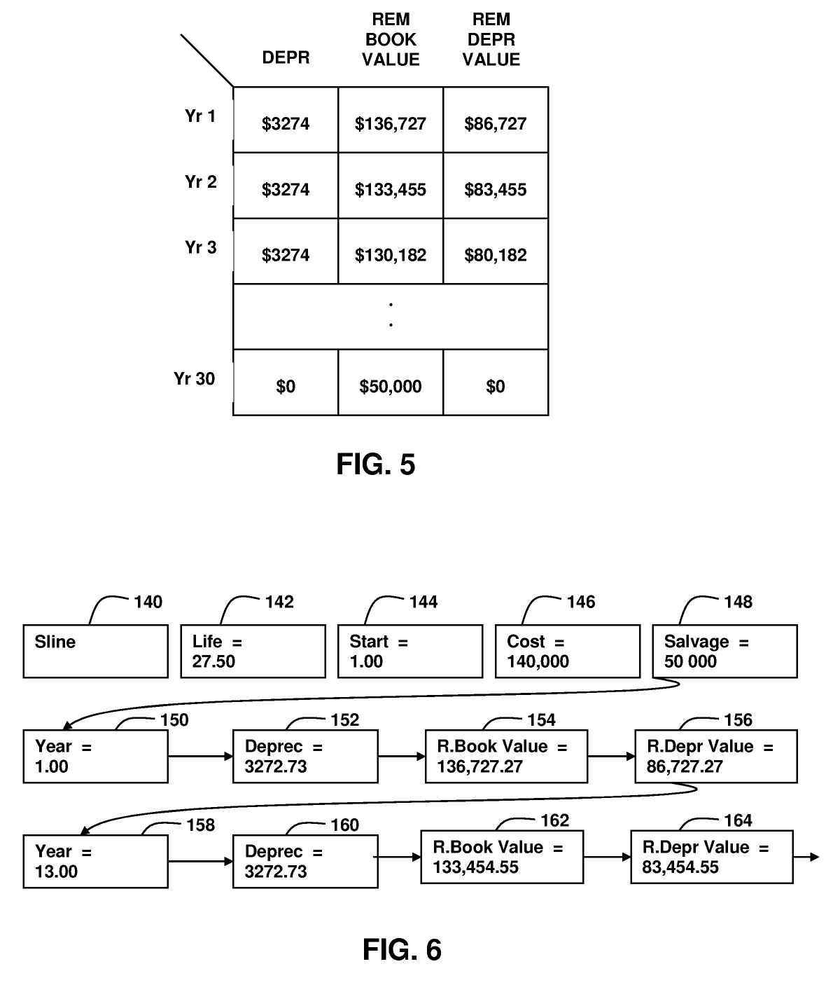

FIG. 5 illustrates a depreciation calculation example. In this example, an asset worth $140,000 is depreciated over 27.5 years and has a salvage value of $50,000. FIG. 5 provides the output data from the depreciation calculation by year. As shown, in the first year the depreciation amount is $3274 (same depreciation amount in each year). The remaining book value is $136,727 and the remaining depreciable value is $86,727. In year 2, the depreciation amount, remaining book value and remaining depreciable value are $3274, $133,455, and $83,455. In the final year (year 28), the depreciation amount and remaining depreciable value are both 0 and the remaining book value is the salvage value, $50,000.

FIG. 6 illustrates what is shown on display 12 as the depreciation example of FIG. 5 is performed and the results shown. For the depreciation calculation, the calculator 10 prompts the user for the required input data. The user first presses the shift and then AMORT keys 18 and 20 to cause the Depr function to be selected. The word “Sline” is shown on the display (140) which refers to straight-line depreciation.” Upon pressing the down arrow key, the display changes to the “Life” indicator and prompts the user to enter a life value (number of years over which to depreciate the asset). In the example of 142, the user has entered 27.5 years (user presses the INPUT key 26 after entering 27.5). The user again presses the down arrow key and the starting time period of 1.00 is displayed (144). This value can be manually changed by the user as desired.

Pressing the down arrow key again causes the calculator 10 to prompt the user to enter the cost of the asset. In the example of 146, the user has entered a cost value of $140,000 and pressed the INPUT key 26. Once again pressing the down arrow key causes the user to be prompted for the salvage value. In the example of 148, the user has entered a salvage value of $50,000 and pressed the INPUT key 26.

Repeatedly pressing the down arrow key 26 from that point on causes the calculator 10 sequence through the depreciation output values of FIG. 5. At 150, the first time period (year=1.00) is shown. As the user presses the down arrow key 26 three more times, the first year's output values are sequentially displayed—depreciation value of $3272.73 (reference numeral 152), remaining book value of $136,727.27 (reference numeral 154) and remaining depreciable value of $86,727.27 (reference numeral 156).

Once the last value of year 1 (remaining depreciable value) displayed, pressing the down arrow key yet again causes the calculator 10 to automatically increment to the next time period (year 2) to cause the output values associated with year 2 to be displayed, upon the user pressing the down arrow key. The time period identifier (year=2.00) is displayed at 158. Pressing the down arrow key three more times causes the depreciation amount of $3282.73 to be displayed (160) followed by the remaining book value of $133,454.55 (reference numeral 162) and remaining depreciable value of $83,454.55 (reference numeral 164). This process including the automatic increment from one time period to the next continues as the user continues to press the down arrow key 24.

As with the amortization calculation, pressing the up arrow key 22 in the depreciation calculation causes the output data values to be displayed in the reverse order from that described above with automatic decrement to the preceding time period. In yet other embodiments, there is no automatic decrement to the preceding time period and pressing the up arrow key only causes the calculator 10 to scroll backward through the current time period's output values (e.g., remaining depreciable value to remaining book value to depreciation value).

By automatically incrementing from a current depreciation time period to the subsequent time period (by pressing the down arrow key 24), the user of the calculator 10 need not manually input a new time period to view depreciation data. Further, only one selection key (e.g., down arrow key 24) need be pressed to scroll through some or all of the depreciation output values over the various time periods.

FIG. 7 illustrates a method comprising actions 202-208. At 202, a user enters data on the keyboard 14 of calculator 10. At 204, the user performs a desired financial calculation (e.g., amortization, depreciation). At 206, the calculator the user repeatedly presses the selection button (e.g., down arrow key 24) to cause the calculator to view the output values for each time period. At 208, the calculator automatically increments from a current time period to a subsequent time period upon the user pressing the selection button when all of the current time period's output values have been displayed.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a processor;
a keyboard coupled to the processor, said keyboard comprising a financial calculation key and a selection key; and
a display coupled to the processor;
wherein, when said financial calculation key is pressed, said processor performs a financial calculation, said financial calculation computing financial data over multiple time periods; and
wherein the processor sequences through and displays said computed financial data and automatically increments from a current time period to a subsequent time period upon a user repeatedly pressing the selection key.

2. The system of claim 1 wherein said increment from the current time period to a subsequent time period occurs without a user having to manually enter the subsequent time period.

3. The system of claim 1 wherein the selection key is an arrow key.

4. The system of claim 1 wherein said financial calculation is selected from a group consisting of an amortization calculation and a depreciation calculation.

5. The system of claim 1 wherein the financial data computed by the financial calculation comprises principal, interest and balance.

6. The system of claim 1 wherein the financial data computed by the financial calculation comprises depreciation, remaining book value, and remaining depreciable value.

7. The system of claim 1 wherein said system is a hand-held calculator.

8. A method, comprising:
entering data on a calculator keyboard to perform a financial calculation, said financial calculation comprising a multi-time period listing of results, and time period comprising at least one output value;
performing said financial calculation;
repeatedly pressing a selection button on said calculator keyboard to view each of said at least one output value for each time period of said calculation so performed; and
automatically incrementing from a current time period to a subsequent time period upon pressing said selection button when having displayed all of the output value of a current time period.

9. The method of claim 8 further comprising displaying all of the at least one output values of all time periods by only repeatedly pressing the selection button and without pressing any other button on the calculator.

10. The method of claim 8 wherein the financial calculation is selected from a group consisting of an amortization calculation and a depreciation calculation.

11. The method of claim 8 wherein the at least one output value comprises principal, interest and balance.

12. The method of claim 8 wherein the at least one output value comprises depreciation, remaining book value, and remaining depreciable value.

13. A hand-held calculator, comprising:
logic contained within a hand-held housing;
a keyboard coupled to the logic and also contained within said housing, said keyboard comprising a financial calculation key and a selection key; and
a display coupled to the processor and also contained within said housing;
wherein, when said financial calculation key is pressed, said processor performs a financial calculation, said financial calculation computing financial data over multiple time periods; and
wherein the processor sequences through and displays said computed financial data and automatically increments from a current time period to a subsequent time period upon a user repeatedly pressing only the selection key.

14. The hand-held calculator of claim 13 wherein said financial calculation is selected from a group consisting of an amortization calculation and a depreciation calculation.

15. The hand-held calculator of claim 13 wherein said computed financial data comprises one or more data selected from a group consisting of principal, interest, balance, depreciation, remaining book value, and remaining depreciable value.
